(19) United States
(12) Patent Application Publication
(10) Pub. No.: US 2010/0283298 A1
(43) Pub. Date: Nov. 11, 2010

(54) Safety Seat Suspended on Vertically Extending Retaining Strap Loops

(75) Inventor: Holger Hansen, Hamburg (DE)

Correspondence Address: ROBERT W. BECKER & ASSOCIATES, 707 HIGHWAY 333, SUITE B, TIJERAS, NM, 87059-7507, US

(73) Assignee: AUTOFLUG GMBH, RELLINGEN (DE)

(21) Appl. No.: 12/811,954

(22) PCT Filed: Jan. 7, 2009
(86) PCT No.: PCT/EP2009/000022

§ 371 Date: Jul. 7, 2010

(30) Foreign Application Priority Data
Jan. 21, 2008 (DE) 10 2008 005 422.4

(51) Int. Cl. B60N 2/427; B64D 25/04; B64D 11/06; B63B 29/04; B63B 17/00

(52) U.S. Cl. 297/216.16

(57) ABSTRACT

Safety seat for land vehicles, aircraft, and watercraft. A seat portion frame forms a seat portion, and a backrest frame, connected to the seat portion frame and disposed at an angle thereto, forms a backrest. Two vertical, vehicle-mounted retaining straps are disposed near the rear edge of the seat portion. Each retaining strap is a strap loop mounted between vehicle-mounted anchors that are spaced vertically apart. The strap loop has a front strap facing the safety seat, and a rear strap spaced from the front strap. The front and rear straps are respectively alternatingly guided over an upper cross member of the backrest frame and, in the region of the seat portion frame, a lower cross member of the backrest frame such that when the strap loop is tensioned, the front and rear straps clamp the upper and lower cross members between them. The backrest frame is suspended on at least one suspension strap secured to a further vehicle-mounted anchor above the safety seat.

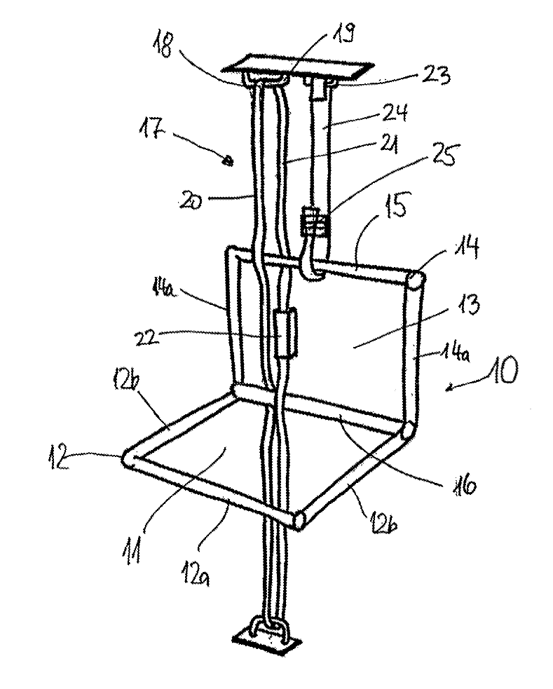

The present invention relates to a safety seat for land vehicles, aircraft and watercraft, and includes at least one seat portion, which is fixed in position on two vertical retaining straps that each extend in the region of the rear edge of the seat portion, and are mounted to the vehicle.

A safety seat having the aforementioned features is known from DE 10 2004 06 2350 B3. Here, the seat portion, which is embodied as a compression-resistant component, is respectively secured to retaining straps that are vertically mounted between the roof of the vehicle and the floor of the vehicle, with the seat portion being fixed in position on the vertical retaining straps via additionally provided, lateral support straps that are connected to the vertical retaining straps and with them form a strap structure for supporting the seat portion. In this connection, the lateral support straps are comprised of strap portions that extend from a lower, stationary position of attachment, along the side edges of the seat portion, and to the front corner points thereof, whereby from the front corner points of the seat portion a respective further strap portion, which extends at an angle to the vertical axis of the vehicle seat, is guided back to an upper stationary point of attachment on the associated vertical retaining strap. Thus, the seat portion, which is embodied as a compression-resistant component, is placed into the strap structure formed of vertical retaining straps and support straps in such a way that the seat portion automatically tensions the strap structure. In this connection, pursuant to one embodiment there is additionally provided that the seat portion be able to be folded up in the strap structure, whereby the folding up is effected by raising the rear end of the seat portion by means of a separate actuating cable.

The known safety seat has the drawback that the lateral support straps laterally encloses an occupant seated on the safety seat, so that when the occupant stands up, he or she can only rise up toward the front, and can also be seated on the seat only from a position disposed in front of the seat. However, there are frequently applications where a plurality of seats are disposed next to one another in a row oriented in the direction of travel of the vehicle, whereby the occupants, especially when getting out of the seats, slide to the side over the seats disposed next to one another and leave the vehicle from the last seat of the row.

It is therefore an object of the present invention to improve a safety seat having the aforementioned features in such a way that, as previously, with a support of the seat portion on a strap structure, laterally of the seat portion no components that obstruct a movement of the occupant are present.

The realization of this object, including advantageous embodiments and further developments of the invention, result from the content of the patent claims, which follow this description.

The basic concept of the present invention is that the safety seat includes a seat portion frame, which forms the seat portion, and a backrest frame, which is connected therewith, is disposed at an angle thereto, and forms a backrest, and each retaining strap is embodied as a strap loop that is mounted between vehicle-mounted anchors, which are vertically spaced relative to one another, and has a front strap which faces the safety seat, and a rear strap which is spaced therefrom, whereby front strap and rear strap are respectively alternatingly guided over the upper cross member as well as the lower cross member, disposed in the region of the seat portion frame, of the backrest frame in such a way that front strap and rear strap, with the strap loop tensioned, clamp the cross members between them, and in that the backrest frame is suspended in at least one suspension strap, which is secured on a vehicle-mounted anchor disposed vertically above the safety seat.

The present invention has the advantage that the safety seat is already fixed in position on the vertically mounted retaining straps in that the front and rear straps of the retaining strap loops, which are installed with an appropriate tension, clamp the associated cross members of the safety seat between them; the holding forces applied by means of this clamping are in principle already adequate to fix the safety seat in position on the vertical retaining straps without further components, so that in particular no lateral bracing is required. In this way, due to the inventive path of the front straps and the rear straps, it is possible in a straightforward manner to fix the safety seat in position in various height positions, in other words respectively at a different distance relative to the vehicle floor. For safety reasons, the present invention additionally provides for suspension of the safety seat by means of a suspension strap that is secured to a vehicle-mounted anchor disposed vertically above the safety seat so that by means of the dimensioning of the length of the suspension strap, on the one hand the installation position of the safety seat is fixedly provided, and on the other hand also a suitably great stressing of the safety seat does not lead to an unintended shifting of the seat along the retaining strap loops.

The inventive manner of fixing the seat portion in position on a vehicle-mounted strap structure furthermore advantageously ensures that impacts, for example caused by mine explosions, that act in the vertical direction, in other words in the “Z” direction of a vehicle, are absorbed by the retaining strap loops as well as by the suspension straps. On the whole, an increase of the vertical forces that act upon the safety seat therefore result in only a very slight vertical change in position, whereby a dampening of the resulting vertical forces is provided by the expansion characteristics of the straps being used. Furthermore, the inventive safety seat also has the advantages that only few straightforward, and hence economical, components are required, whereby known components and materials can be utilized. The safety seat has only a small overall size accompanied by a light weight, whereby at the same time, however, the safety seat is characterized by a high rigidity and a good load capacity in all directions of load. In addition, existing vehicles can be easily retrofitted with the safety seat.

Pursuant to one specific embodiment of the invention, two suspension straps are provided that are associated with the respective retaining straps.

In addition to the fixation of the safety seat on the retaining straps, the suspension straps can be utilized for a defined guidance of a vehicle-mounted shoulder strap of a safety belt system of the seat in that a suspension strap is provided with a guide-through means for the shoulder strap. Pursuant to a further development of the subject matter of the invention, it can then be provided that where the safety belt system of the seat is provided with a suspender strap, each of the two suspension straps is provided with a guide-through means for the associated shoulder strap of the safety belt system.

In a straightforward embodiment of the invention, the seat portion frame and the backrest frame can be provided with a common cross member, so that front strap and rear strap of the retaining strap loop respectively clamp the upper cross member of the backrest frame, and the common cross member of seat frame and backrest frame, between them. In this connection, the seat portion frame can additionally be disposed so as to be pivotable relative to the common cross member.

Alternatively, it is also possible for the seat portion frame and the backrest frame to have separate cross members, which are oriented parallel and adjacent to one another.

With such a configuration, pursuant to alternative embodiments of the invention, the front strap and rear strap of the strap loop can be guided merely over the cross members of the backrest frame, or the front strap and the rear strap can trap or clamp the two adjacent cross members of the seat portion frame and the backrest frame between them.

In this connection, the rear cross member of the seat portion frame can be disposed on that side of the cross member of the backrest frame that faces the seat portion. Alternatively, the seat portion frame can be extended beyond the associated cross member of the backrest frame, and the rear cross member of the seat portion frame can be disposed on that side of the backrest frame that is remote from the seat portion. Such an embodiment has the advantage that it is possible to fold the seat portion frame up relative to the backrest frame, whereby as a consequence of the arrangement of the cross member of the seat portion frame behind the cross member of the backrest frame, a self-holding effect for the seat portion frame in the folded-up position results. In this connection, it can be advantageous if the seat portion frame is connected with the lower cross member of the backrest frame via a pivot connection.

To better adapt the arrangement of the safety seat to the structural conditions of a vehicle, it is proposed pursuant to one embodiment that each suspension strap be provided with an adjustment mechanism for adapting the length of the suspension strap that extends between the upper vehicle-mounted anchor and the lower cross member of the back rest frame. Thus, with a standardized design of retaining strap loops and suspension straps, a use is possible with any desired vehicle dimensions.

To apply a pretension into the course or run of each strap loop, a tensioning device can be provided, by means of which the tension required for the application of the clamping of the parts of the safety seat can be produced.

One embodiment of the invention is shown in the drawing, and will be described subsequently. The sole FIGURE shows a safety seat along with the pertaining retaining strap arrangement in a schematic view.

The safety seat 10 illustrated in the drawing is provided with a seat portion frame 12, which forms a seat portion 11 and includes a front cross member 12a and side supports 12b, and at its rear end, which is disposed across from the front cross member 12a, is provided with a cross member 16 that at the same time forms a common cross member of a backrest frame 14, which is disposed at an angle to the seat portion frame 12 and together with side supports 14a and an upper cross member 15 forms a backrest 13. In the illustrated position of use, the backrest frame 14 and the seat portion frame 12 are fixedly connected to one another, whereby the front cross member 12a and the side supports 12b of the seat portion frame 12 can be connected with the common cross member 16 of the backrest frame 12 by means of a pivot connection, so that the seat portion frame 12 can be folded up relative to the backrest frame 14.

To suspend the safety seat 10 formed in such a manner in a motor vehicle, respective retaining straps 17 are mounted on the two outer sides of the safety seat 10 between an upper and a lower anchor 19 that is secured to the vehicle, whereby in the drawing, by way of example, only one (left) retaining strap 17 is illustrated. The anchors 19 mounted to the vehicle are embodied as retaining members or brackets that are to be secured to a vehicle body via a base or mounting plate; the retaining strap 17, which forms a circumferential strap loop 18, is looped through the retaining brackets. Due to the configuration of the strap loop 18, there results a front strap 20, which faces the safety seat, and a rear strap 21, which is spaced therefrom. Disposed in the run of the strap loop 18 is a tensioning device 22, by means of which, as a function of the spacing between the vehicle-mounted anchors 19, which spacing is dictated by the vehicle, the pertaining retaining strap 17, i.e. the strap loop 18, can be placed under an appropriate tension.

The support of a safety seat 10 on the strap loops 18 is now realized in a special manner by the paths of the front strap 20 and the rear strap 21 over the upper cross member 15 and the common cross member 16 of the backrest frame 14 in that the front strap 20 and the rear strap 21 respectively are alternatingly guided first in front of and then behind the respective cross member, so that each cross member is clamped in between the front strap 20 and the rear strap 21. By applying an appropriate tension to the retaining strap 17, there results a clamping of the cross members 15 and 16 via the respective front strap 20 and rear strap 21, so that as a consequence of these introduced clamping forces, already an adequate fixing of the safety seat 10 in position on the retaining strap 17 results.

A suspension strap 24 serves for an additional fixation of the safety seat; the suspension strap is secured to a vehicle-mounted anchor 23, and its free end is looped about the upper cross member 15 of the backrest frame 14, so that the safety seat 10 is suspended on this suspension strap 24. Once again, with the illustrated embodiment only one (left) suspension strap 24 is illustrated; customarily, just as two retaining straps 17 are provided, also two suspension straps 24 are provided. To ensure installation of the strap system with the safety seat 10 when encountering different vehicle dimensions, the suspension strap 24 is provided with an adjustment mechanism 25 for adjusting its length.

The features of the subject matter of these documents disclosed in the preceding description, the patent claims, the abstract and the drawing can be important individually as well as in any desired combination with one another for realizing the various embodiments of the invention.

1-14. (canceled)

15. A safety seat for land vehicles, aircraft, and watercraft, comprising:
a seat portion frame (12) that forms a seat portion (11);
a backrest frame (14) connected to said seat portion frame (12) and disposed at an angle to said seat portion frame (12), wherein said backrest frame (14) forms a backrest (13), and wherein said backrest frame includes an upper cross member (15) and, in the region of said seat portion frame (12), a lower cross member (16);
anchors (19) configured to be mounted to a vehicle, wherein pairs of said anchors (19) are configured to be spaced vertically apart;
two retaining straps (17) configured to be mounted to the vehicle and to extend vertically, wherein said retaining straps (17) are disposed in the region of a rear edge of said seat portion (11), further wherein said seat portion frame (12) is configured to be fixed in position on said retaining straps (17), further wherein each of said retaining straps (17) is embodied has a strap loop (18) mounted between anchors of a pair of vertically spaced apart ones of said anchors (19), further wherein said strap loop (18) as a front strap (20) facing said safety seat (10) and a rear strap (20) that is spaced from said front strap (20), and wherein said front and rear straps (21) are respectively alternatingly guided over said upper and lower cross members (15, 16) of said backrest frame (14) such that when said strap loop (18) is in a tensioned state, said front and rear straps (20, 21) clamp between them said upper and lower cross members (15, 16);
at least one further anchor (23) configured to be mounted to the vehicle for disposition above said safety seat (10); and
at least one suspension strap (24) secured to said at least one further anchor (23), wherein said backrest frame (14) is suspended on said at least one suspension strap (24).

16. A safety seat according to claim, which includes two suspension straps (24), each of which is associated with a respective one of said retaining straps (17).

17. A safety seat according to claim 16, wherein at least one of said suspension straps (24) is provided with a guide-through means for a vehicle-mounted shoulder strap of a safety belt system of said safety seat.

18. A safety seat according to claim 16, wherein a safety system of said safety seat is provided with a suspender strap, and wherein both of said suspension straps (24) are provided with a respective guide-through means for an associated shoulder strap of the safety belt system.

19. A safety seat according to claim 15, wherein said seat portion frame (12) and said backrest frame (14) share a common cross member (16).

20. A safety seat according to claim 19, wherein said seat portion frame (12) is configured to be pivotable relative to said common cross member (16).

21. A safety seat according to claim 15, wherein said seat portion frame (12) and said backrest frame (14) are provided with separate cross members that are oriented parallel and adjacent to one another.

22. A safety seat according to claim 21, wherein said front and rear straps (20, 21) of said strap loop (18) are guided only over said cross members of said backrest frame (14).

23. A safety seat according to claim 21, wherein said front and rear straps (20, 21) of said strap loop (18) trap between them the two cross members of said seat portion frame (12) and said backrest frame (14).

24. A safety seat according to claim 21, wherein a rear one of the cross members of said seat portion frame (12) is disposed on that side of a cross member of said backrest frame (14) that faces said seat portion (11).

25. A safety seat according to claim 21, wherein said seat portion frame (12) is extended beyond an associated one of the cross members of said backrest frame (14), and wherein a rear one of the cross members of said seat portion frame (12) is disposed on that side of said backrest frame (14) that is remote from said seat portion (11).

26. A safety seat according to claim 25, which includes a pivot connection, wherein said seat portion frame (12) is connected with a lower one of the cross members of said backrest frame (14) via said pivot connection.

27. A safety seat according to claim 15, wherein said at least one suspension strap (24) is provided with an adjustment mechanism (25) for adaptation of a length of said suspension strap (24), and wherein said suspension strap (24) extends between said further vehicle-mounted anchor (23) and said upper cross member (15) of said backrest frame (14).

28. A safety seat according to claim 15, which includes a tensioning device (22) configured to apply a tension into the run of each of said strap loops (18).
